(19) United States
(12) Patent Application Publication
(10) Pub. No.: US 2022/0253377 A1
(43) Pub. Date: Aug. 11, 2022

(54) REGRESSION TESTING OF APPLICATIONS BASED ON SOURCE CODE CHANGE LOCATIONS AND SOURCE CODE TEST LOCATIONS

(71) Applicant: Hewlett-Packard Development Company, L.P., Spring, TX (US)

(72) Inventors: Mauricio Coutinho Moraes, Porto Alegre (BR); Daniele Antunes Pinheiro, Porto Alegre (BR); Jhonny Marcos Acordi Mertz, Porto Alegre (BR)

(73) Assignee: Hewlett-Packard Development Company, L.P., Spring, TX (US)

(21) Appl. No.: 17/613,518

(22) PCT Filed: Sep. 12, 2019
(86) PCT No.: PCT/US2019/050718

§ 371 Date: Nov. 23, 2021

(51) Int. Cl. G06F 11/36; G06F 8/71

(52) U.S. Cl. CPC G06F 11/3688; G06F 8/71; G06F 11/3696

(57) ABSTRACT

An example system includes a source code change engine to: retrieve a source code change location in an application, as maintained at a first database. The example system further includes: a source code test location engine to: retrieve a source code test location, tested by a regression test, as maintained at a second database in association with the regression test. The example system further includes: a regression test selection engine to: select the regression test to test the application based on comparing the source code change location for the application with the source code test location associated with the regression test. The example system further includes: a regression test engine to: execute the regression test, as selected, on the source code test location of the application; and in response to the application passing the regression test, return an indication of passing the regression test.

### BACKGROUND

Regression testing in continuous integration environments can be a time-consuming process as some form of automatic analysis may be used to determine locations in source code that have changed so that the code can be regression tested and deployed.

### BRIEF DESCRIPTION OF THE DRAWINGS

Reference will now be made, by way of example only, to the accompanying drawings in which:

FIG. 1 is a block diagram of an example system to implement regression testing of applications based on source code change locations and source code test locations.

FIG. 2 a block diagram of another example system to implement regression testing of applications based on source code change locations and source code test locations.

FIG. 3 is a flow diagram of an example method to implement regression testing of applications based on source code change locations and source code test locations.

FIG. 4 is a block diagram of an example computer-readable medium including instructions that causes a processor to implement regression testing of applications based on source code change locations and source code test locations.

FIG. 5 is an example of a code snippet which includes execution location markers to generate source code test locations.

FIG. 6 is a block diagram of an example system to selecting a regression test based on source code change locations and source code test locations.

FIG. 7 is a block diagram of an example system to executing a selected regression test and updating source code test locations

### DETAILED DESCRIPTION

Continuous Integration (CI) is a development practice where integration of code changes from multiple contributors to source code occurs, for example when developing and/or maintaining applications. Regression testing in a CI environment can be a time-consuming process as some form of automatic analysis may be used to determine regression tests that test changed source code locations may be used. Such automatic analysis can be time consuming and hence challenging to deploy in CI environments where thousands of code changes may be tested daily for deployment.

In general, regression tests are tests which test an application and/or source code to confirm whether a source code change has not adversely affected the application. Regression testing may occur by using all available regression tests to test the application (e.g., a retest-all method), however such an approach may be a waste of processing resources when only a portion of the application has changed, such as a particular path and/or particular conditional path; such an approach may also be time consuming.

However, as described herein, an application may be made “self-aware” by providing the application with execution location markers which return indicators identifying a source code location at which an executed location marker is located. For example, the execution location markers may return line numbers which indicate that source code associated with the execution location markers has been executed. For example, an execution location marker may be part of a path and/or conditional path of the source code of the application; hence, when a source code location is returned by an execution location marker, the source code location indicates that the associated path and/or the associated conditional path was executed. Such source code locations returned when a regression test is executed on an application may be stored as source code test locations of the application associated with the regression test, and may be used to later select regressions tests that test changed source code locations, and exclude regression tests that do not test changed source code locations.

Hence, provided herein is a system comprising: a source code change engine to: retrieve a source code change location in an application, as maintained at a first database; a source code test location engine to: retrieve a source code test location, tested by a regression test, as maintained at a second database in association with the regression test; a regression test selection engine to: select the regression test to test the application based on comparing the source code change location for the application with the source code test location associated with the regression test; and a regression test engine to: execute the regression test, as selected, on the source code test location of the application; and in response to the application passing the regression test, return an indication of passing the regression test.

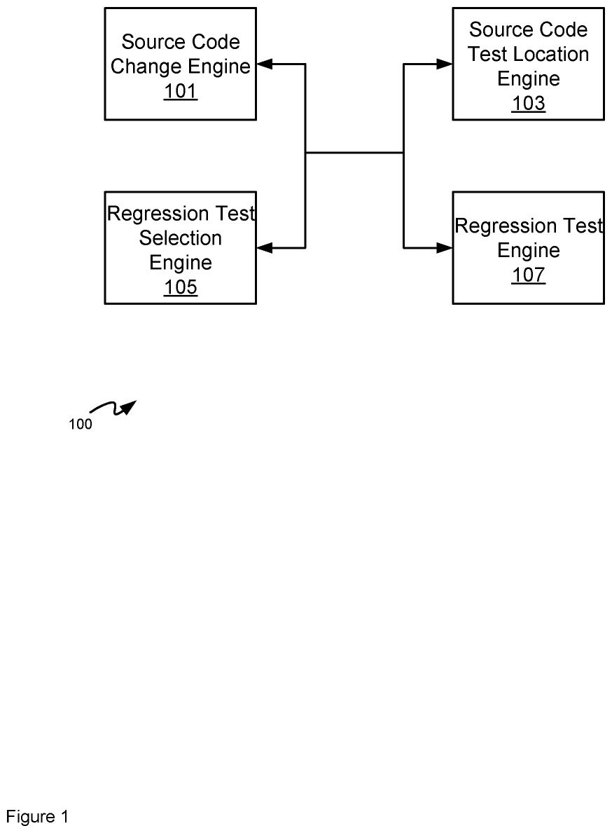

FIG. 1 is a block diagram of an example system 100 to implement regression testing of applications based on source code change locations and source code test locations. The system 100 may include a source code change engine 101, a source code test location engine 103, a regression test selection engine 105 and a regression test engine 107 in communication with each other (e.g., as represented by arrows therebetween).

As used herein, the term “engine” refers to hardware (e.g., a processor, such as a central processing unit (CPU) an integrated circuit or other circuitry) or a combination of software (e.g., programming such as machine- or processor-executable instructions, commands, or code such as firmware, a device driver, programming, object code, etc.) and hardware. Hardware includes a hardware element with no software elements such as an application specific integrated circuit (ASIC), a Field Programmable Gate Array (FPGA), etc. A combination of hardware and software includes software hosted at hardware (e.g., a software module that is stored at a processor-readable memory such as random access memory (RAM), a hard-disk or solid-state drive, resistive memory, or optical media such as a digital versatile disc (DVD), and/or implemented or interpreted by a processor), or hardware and software hosted at hardware. Furthermore the engines described herein may be combined at a hardware element and/or hardware elements.

For example, the source code change engine 101 may comprise hardware or a combination of software and hardware for implementing functionality to: retrieve a source code change location in an application, as maintained at a first database. The source code change engine 101 may comprise a portion of a server which hosts the source code change engine 101. However, the source code change engine 101 may comprise hardware or a combination of software and hardware of any suitable computing device.

The source code change engine 101 is generally in communication with a first database (not depicted), and the like, at which source code change locations are maintained, for example in a CI environment. In particular, as changes to source code of applications are made, the first database is updated with locations of the changes in the applications. For example, the locations may be stored as a line number and/or line numbers and/or a range of line numbers of the source code of the application at which changes were made. Such changes may include changing a line, or lines, of source code, adding a line, or lines, of source code, removing a line, or lines, of source code, and the like. As changes to the source code are made, the first database is updated, either manually or automatically (e.g., using a version control application, and the like) at the first database to indicate locations in the source code that were made.

The source code change engine 101 is hence to: retrieve a source code change location in an application, as maintained at the first database.

Various regression tests may be implemented to test an application at which source code changes were made, to test the integrity of the application (e.g., to test whether the source code changes had an adverse effect on the application). In general, a regression test may be to test a portion and/or particular location of the application which is referred to hereafter as a source code test location. For example, a particular regression test may be to test a particular path and/or a particular conditional path of the source code in the application.

Hence, as described hereafter, a second database (which may be combined with the first database and/or separate from the first database) may be maintained which stores a source code test location and/or locations that are tested by a particular regression test. For example, the second database may store an identifier of a regression test in association with the source code test location(s) tested by the regression test. In some examples, the source code test location(s) may be a line number and/or line numbers and/or a range of line numbers of the source code of the application tested by the regression test. The regression test may further be to test more than one application, and the second database may store different test source code test locations for different applications. Indeed, the second database may store an identifier of a regression test in association with the source code test location(s) tested by the regression test and a respective identifier of the application of the source code test location(s) that include the source code test location(s). Population of the second database is described in more detail below; however, the second database may be populated using execution location markers in the source code of the application, for example when a regression test is first implemented on the application, and then maintained at subsequent implementations of a regression test on the application.

The source code test location engine 103 is hence to: retrieve a source code test location, tested by a regression test, as maintained at the second database in association with the regression test. Thus the source code test location engine 103 may retrieve, from the second database, the line numbers of the application that is tested by a particular regression test.

The regression test selection engine 105 is to: select the regression test to test the application based on comparing the source code change location (e.g., as retrieved from the first database) for the application with the source code test location associated with the regression test (e.g., as retrieved from the second database).

For example, the regression test selection engine 105 may compare a line number and/or numbers of the source code change location with a line number and/or numbers of the source code test location; when they align and/or partially align, and/or when a match and/or partial match is found, the regression test is selected to test the application. An alignment (and/or partial alignment) and/or a match (and/or partial match) may occur when a line number and/or a range of line numbers of the source code change location overlaps with a respective line number and/or a respective range of line numbers of the source code test location.

The regression test engine 107 is to: execute the regression test, as selected (e.g., by the regression test selection engine 105), on the source code test location of the application; and in response to the application passing the regression test, return an indication of passing the regression test.

Hence, for example, all available regression tests are not executed by the regression test engine 107; rather, changed source code locations are used to select regression tests that test source code test locations that include the changed source code locations. Regression tests that test source code test locations that do not include the changed source code locations may be excluded from testing. Such a scheme may reduce use of processing resources to test the source code change locations. Furthermore, comparing the source code change location with the source code test location to select a regression test may obviate complex automatic analysis which may be used to determine regression tests that test changed source code locations.

An indication returned by the regression test engine 107 may be stored in a version control database; the indication may indicate that a version of the application, that includes the source code change locations, is to be deployed and/or replace a previous version of the application. For example, the application may be a website, and the like, and the version of the website, that includes the source code change locations, is to be deployed and/or replace a previous version of the website, for example at a server and/or other computing device which implements the website. Hence, when the version control database, and the like, stores an indication of a version of an application passing a regression test, the version of the application may be deployed in any suitable manner, for example at a scheduled deployment time and/or in response to the indication being stored, and the like.

Hence, the regression test engine 107 may be further to: in response to the application passing the regression test, deploy the application and/or cause the application to be deployed. Put another way, the regression test engine 107 and/or the system 100, may be a component of a CI environment which deploys and/or releases versions of applications in response to the versions of the applications passing regression tests. The regression test engine 107 returning the indication of a version of an application passing the regression test may trigger deployment and/or release of the version of the application within the CI environment.

Put yet another way, the regression test engine 107 may be further to: return the indication of passing the regression test by marking the application as a release candidate in a CI environment, for example in a version control database.

However, the application may alternatively fail a regression test. As such, the regression test engine 107 may be further to: in response to the application failing the regression test, return a respective indication of failing the regression test. Such a respective indication of the application failing the regression test may be returned to a computing device of a developer that made the changes at the source code change location; such a respective indication may indicate that further changes are to be made and/or that the changes at the source code change location may be in error.

The respective indication of failing the regression test may also be stored in a version control database to prevent deployment and/or release of the version of the application that includes the source code change location in the CI environment. Put another way, the regression test engine 107 may be further to: return the respective indication of failing the regression test by marking the application as not a release candidate in a CI environment, for example in a version control database.

While the system 100 is described with respect to one regression test, a plurality of regression tests may be available to test an application which includes a source code change location. The second database may store respective source code test locations, tested by a plurality of regression tests, in association with the plurality of regression tests. Hence, the regression test selection engine 105 may be further to select more than one regression test to test a source code change location based on comparing the source code change location with the respective source code test locations of the plurality of regression tests. In response to determining alignment and/or partial alignment, and/or a match and/or partial match, between the source code change location and more than one respective source code test location, the regression test selection engine 105 may select more than one of the plurality of regression tests to test the source code change location of the application.

In particular, the regression test selection engine 105 may be further to: select a plurality of first regression tests to test the source code change locations changed in the application based on determining the source code change locations that align (and/or partially align, and the like) with first respective source code test locations tested by the plurality of first regression tests; and exclude a plurality of second regression tests from testing the application based on determining the source code change locations do not align with second respective source code test locations tested by the plurality of second regression tests.

Put another way, the regression test selection engine 105 may be further to: exclude a second regression test from testing the application when the source code change locations of the application do not align with respective source code test locations tested by the second regression test.

In yet further examples, the system 100 may be to update the second database with source code test locations, for example in response to testing the regression test engine 107 testing the application.

In particular, while not depicted in FIG. 1, the system 100 may further comprise a source code location update engine to: receive, from the application, an executed source code location that was executed during the regression test; and update the source code test location associated with the regression test, at the second database, with the executed source code location. For example, the executed source code location may comprise a line number returned by an execution location marker of the executed source code location. The execution location marker may be in a path and/or conditional path of the source code test location. Hence, put another way, the source code location update engine may be to: receive, from the application, an executed source code location that indicates a path and/or conditional path that was executed during the regression test; and update the source code test location associated with the regression test, at the second database, with the executed source code location. Such examples may generally obviate analyzing an application for locations to test by a given regression test.

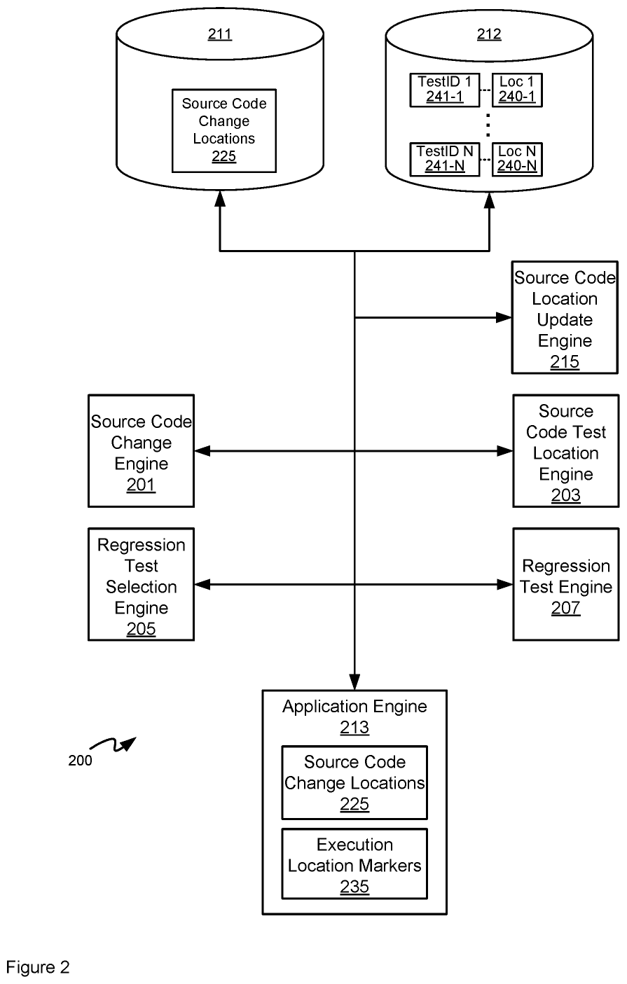

Attention is next directed to FIG. 2 which is a block diagram of another example system 200 to implement regression testing of applications based on source code change locations and source code test locations.

The system 200 is substantially similar to the system 100, with like components having like numbers, but in a “200” series rather than a “100” series. For example, the system 200 may include a source code change engine 201, a source code test location engine 203, a regression test selection engine 205 and a regression test engine 207; the source code change engine 201, the source code test location engine 203, the regression test selection engine 205 and the regression test engine 207 are respectively similar to the source code change engine 101, the source code test location engine 103, the regression test selection engine 105 and the regression test engine 107, as described above.

However, in contrast to the system 100, in the system 200 further includes a first database 211, a second database 212, an application engine 213 and a source location update engine 215.

While the databases 211, 212 are depicted as separate from each other, the databases 211, 212 may be at least partially combined. Furthermore, while the term “database” is used throughout the present specification, any database referred to herein may alternatively be referred to as a memory and/or memories, and/or a repository and/or repositories. Put another way, a memory and/or memory, and/or a repository and/or repositories, of a computing device may include the databases 211, 212.

The application engine 213 is generally to implement source code of an application, for example, a website and the like, and includes source code change locations 225, as described above, that are also stored at the first database 211. Mechanisms for determining the source code change locations 225, for example in a CI environment, are described above, however any suitable mechanism for determining the source code change locations 225 and storing at the first database 211 is within the scope of the present specification.

The regression test engine 207 may be to: execute a regression test (e.g., selected by the regression test selection engine 205) on a source code test location of an application as implemented by the application engine 213; and in response to the application (e.g., as implemented by the application engine 213) passing the regression test, return an indication of passing the regression test, as described above.

In other words, the functionality of the engines 201, 203, 205, 207 may be implemented with respect to the application engine 213 being controlled to implement and/or execute an application.

The application engine 213 further includes execution location markers 235, as described above; an execution location marker 235 may a return a source code location, such as a line number, when a path and/or a conditional path of the source code of the application that includes an execution location marker 235 is executed.

Hence, a source code location, such as a line number, generated by an execution location marker 235, and returned by the application engine 213, indicate locations of source code tested by a regression test.

As will be described in more detail below, the execution location markers 235 may generally comprise functions and/or engines and/or executable instructions, and the like, which return a source code location, such as a line number, when a path and/or a conditional path of the source code of the application that includes an execution location marker 235 is executed.

As depicted, the second database 212 stores a plurality of source code test locations 240-1 . . . 240-N in association with identifiers 241-1 . . . 241-N of regression tests, where N is an integer corresponding to a number of regression tests that may be used to test the application implemented by the application engine 213. For example, a regression test identified by the identifier 241-1 may be to test a source code test location 240-1 (and/or source code test locations 240-N) of the application implemented by the application engine 213.

While not depicted, the second database 212 may store an identifier of the application (e.g., an application identifier) implemented by the application engine 213, in association with the source code test locations 240-1 . . . 240-N and the identifiers 241-1 . . . 241-N.

Hereafter, the source code test locations 240-1 . . . 240-N will be interchangeably referred, collectively, as the source code test locations 240, and, generically, as a source code test location 240; similarly, the identifiers 241-1 . . . 241-N will be interchangeably referred, collectively, as the identifiers 241 and, generically, as an identifier 241.

While not depicted, the second database 212, and/or another database, generally stores source code, and the like, for implementing the regression tests.

The source location update engine 215 may be to: receive, from the application engine 213 (and/or the application executed by the application engine 213), an executed source code location that was executed during a regression test; and update a source code test location 240 associated with the regression test, at the second database 212, with the executed source code location. Hence, when a regression test is executed on a source code test code location 240, as stored in the second database 212, the application engine 213 may return line numbers, and the like, generated by the execution location markers 235, which may be the same as, or different from, the source code test location 240 stored in association with an identifier 241 of the regression test at the second database 212; the line numbers may hence indicate updated source code test locations 240 tested by the regression test, and the second database 212 may be updated accordingly.

A first time a regression test is executed, the second database may store no associated source code test code locations 240 and hence the regression test may be executed on the entire application; however the line numbers returned by the execution location markers 235 the first time the regression test may be stored at the second database 212 as a source code test location 240 for the regression test. Subsequent executions of the regression test may then be based on the stored source code test location 240. Hence, the execution location markers 235 cause an application to be “self-aware” such that lines numbers that are executed are determined by the application.

While not depicted, the application engine 213 may be further to execute more than one application and/or the system 200 may comprise more than one application engine 213 to execute more than one application. The first database 211 may store source code change locations 225 for more than one application, and the second database 212 may store application identifiers of applications implemented by the system 200 in association with source code test locations 240 of the applications, and identifiers 241 of regression tests for testing the applications.

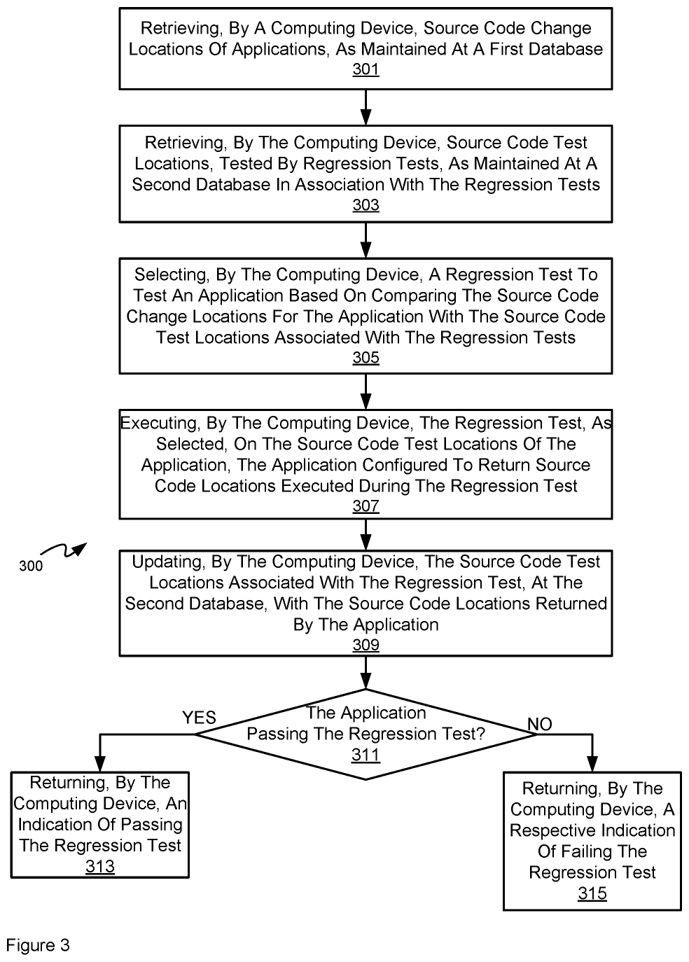

Referring to FIG. 3, a flowchart of an example method 300 to implement regression testing of applications based on source code change locations and source code test locations is depicted. In order to assist in the explanation of method 300, it will be assumed that method 300 may be performed with the system 200, and at least partially by a computing device implementing the system 200 and/or a processor thereof. Indeed, the method 300 may be one way in which the system 200 may be configured. Furthermore, the following discussion of method 300 may lead to a further understanding of the system 200, and its various components. Furthermore, it is to be emphasized, that method 300 may not be performed in the exact sequence as shown, and various blocks may be performed in parallel rather than in sequence, or in a different sequence altogether. Furthermore, it is to be emphasized that the method 300 may alternatively be performed with the system 100, and at least partially by a computing device implementing the system 100 and/or a processor thereof

Beginning at a block 301, a computing device retrieves the source code change locations 225 of applications, as maintained at the first database 211.

At a block 303, the computing device retrieves source code test locations 240, tested by regression tests, as maintained at the second database 212 in association with the regression tests (e.g., as identified by the associated identifier 241).

At a block 305, the computing device selects a regression test to test an application based on comparing the source code change locations 225 for the application with the source code test locations 240 associated with the regression tests. Such a comparison is described above.

At a block 307, the computing device executes the regression test, as selected, on the source code test locations 240 of the application, the application configured to return source code locations executed during the regression test. For example, the computing device may execute the regression test by the application engine 213 receiving input from the regression test that may include the line numbers of an associated source code test location 240 such that the associated source code test location 240 is executed and not the remainder of an application implemented by the application engine 213.

The source code locations may comprise line numbers returned by the execution location markers 235.

At a block 309, the computing device updates the source code test locations 240 associated with the regression test, at the second database 212, with the source code locations returned by the application. In some examples, the source code test locations 240 may be updated when the source code locations returned by the application are different from the source code test locations 240 associated with the regression test and/or the source code test locations 240 may be not be updated when the source code locations returned by the application are not different from the source code test locations 240 associated with the regression test. In other examples, the source code test locations 240 associated with the regression test are updated, at the second database 212, with the source code locations returned by the application regardless of whether the source code test locations 240 and the source code locations are the same or different.

Furthermore, the computing device may update the source code test locations 240 associated with the regression test, at the second database 212, with the source code locations returned by the application, regardless of the results of the regression test, as described hereafter.

At a block 311, the computing device determines whether the application has passed the regression test. For example, the computing device may have access to “expected” data (e.g., data previously generated by the application during functional testing) corresponding to the application passing the regression test. The computing device may determine whether the application has passed the regression test by comparing data returned by the application during the regression test is the same or different as the expected data. In response to the data returned by the application during the regression test being the same as the expected data, the computing device may determine that the application has passed the regression test. Similarly, in response to the data returned by the application during the regression test being different from the expected data, the computing device may determine that the application has failed the regression test. Alternatively, the computing device may determine that the application has failed the regression test in response to the application returning and exception and/or an error (however, in some examples, the application returning and exception and/or an error may be “expected” data). Any suitable process for determining whether an application has passed a regression test is within the scope of the present specification.

In response to the application passing the regression test (e.g., a “YES” decision at the block 311), at a block 313, the computing device: returns an indication of passing the regression test. A version control database may be updated accordingly with the indication of passing the regression test, as described above, so that the version of the application that includes the source code change locations 225 may be deployed. Hence, the block 313 may include the computing device marking the application as a release candidate in a continuous integration environment, for example at a version control database.

In response to the application failing the regression test (e.g., a “NO” decision at the block 311), at a block 315, the computing device: returns a respective indication of failing the regression test. A version control database may be updated accordingly with the respective indication of failing the regression test, as described above, so that the version of the application that includes the source code change locations 225 is not deployed. Hence, the block 313 may include the computing device marking the application as not a release candidate in a continuous integration environment, for example at a version control database.

As should now be clear, the source code change locations 225, the source code test locations 240, and the source code locations returned by the application (e.g., by the execution location markers 235) may comprise source code line numbers.

Furthermore, while the method 300 is described with respect to one regression test, the method 300 may be applied to a plurality of regression tests, for example as identified by the identifiers 241.

The method may hence include the computing device: selecting a plurality of first regression tests, including the regression test of the block 305, to test the source code change locations 225 changed in the application based on determining the source code change locations 225 that align with first respective source code test locations 240 tested by the plurality of first regression tests; and exclude a plurality of second regression tests from testing the application based on determining the source code change locations 225 do not align with second respective source code test locations 240 tested by the plurality of second regression tests. Similarly, the method 300 may include the computing device: excluding a second regression test from testing the application when the source code change locations 225 of the application do not align with respective source code test locations 240 tested by the second regression test.

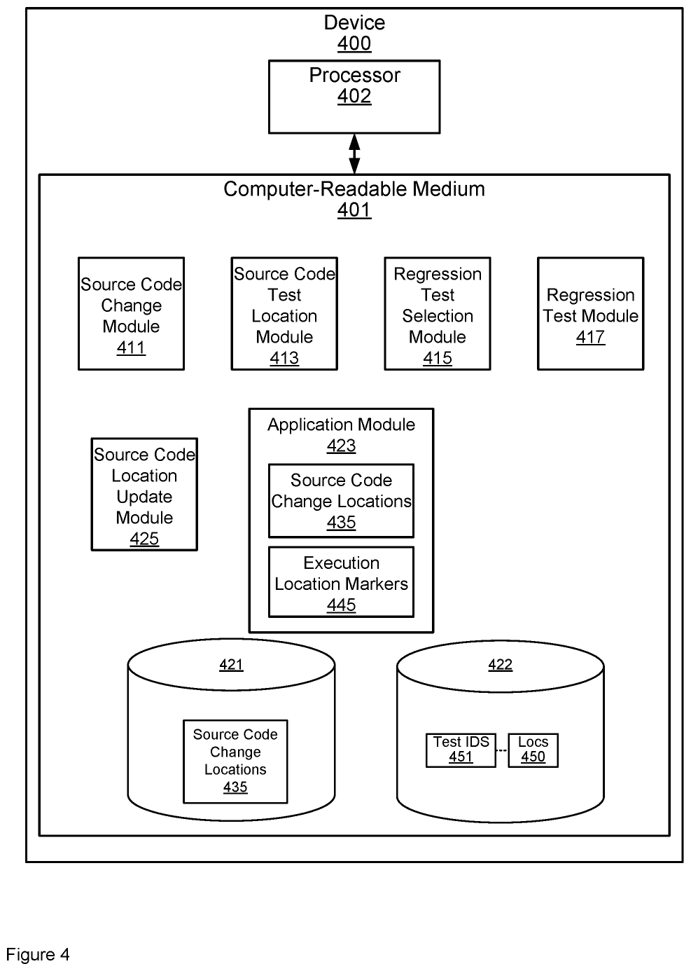

FIG. 4 is a block diagram of an example device 400 that includes a computer-readable medium 401 and a processor 402. The computer-readable medium 401 includes instructions that, when implemented by the processor 402, cause the processor 402 to implement regression testing of applications based on source code change locations and source code test locations.

The computer-readable medium 401 may be a non-transitory computer-readable medium, such as a volatile computer-readable medium (e.g., volatile RAM, a processor cache, a processor register, etc.), a non-volatile computer-readable medium (e.g., a magnetic storage device, an optical storage device, a paper storage device, flash memory, read-only memory, non-volatile RAM, etc.), and/or the like.

The processor 402 may be a general-purpose processor or special purpose logic, such as a microprocessor (e.g., a central processing unit, a graphics processing unit, etc.), a digital signal processor, a microcontroller, an ASIC, an FPGA, a programmable array logic (PAL), a programmable logic array (PLA), a programmable logic device (PLD), etc. The computer-readable medium 401 or the processor 402 may be distributed among a plurality of computer-readable media or a plurality of processors.

The computer-readable medium 401 includes modules. As used herein, a “module” (in some examples referred to as a “software module”) is a set of instructions that when implemented or interpreted by a processor or stored at a processor-readable medium realizes a component or performs a method.

As depicted, the computer-readable medium 401 includes: a source code change module 411, a source code test location module 413, a regression test selection module 415 and a regression test module 417, a first database 421, a second database 422, an application module 423 and a source location update module 425. As depicted, the first database 421 stores source code change locations 435 of the application module 423, and the second database 422 stores source code test locations 450 of an application, and/or applications, implemented by the application module 423, and tested by regression tests, for example as identified by identifiers 451 stored in association with the source code test locations 450.

As described above, the source code change locations 435 and the source code test locations 450 may comprise line numbers of the applications.

The source code change module 411 may include instructions that, when implemented, cause the processor 402 to: communicate with the first database 421 to retrieve changed source code change locations 435 of applications, as described above and which may be implemented by the application module 423.

The source code test location module 413 may include instructions that, when implemented, cause the processor 402 to: communicate with the second database 422 to retrieve the source code test locations 450 tested by regression tests, for example as identified by the identifiers 451.

The regression test selection module 415 may include instructions that, when implemented, cause the processor 402 to: select a regression test that tests the source code change locations 435 of an application based on determining the source code change locations 435 that align with the source code test locations 450 tested by regression tests.

In some examples, the regression test selection module 415 may include further instructions that, when implemented, cause the processor 402 to: select a plurality of first regression tests, including the regression test referred to above, to test the source code change locations 435 changed in the application based on determining the source code change locations 435 that align with first respective source code test locations 450 tested by the plurality of first regression tests; and exclude a plurality of second regression tests from testing the application based on determining the source code change locations 435 do not align with second respective source code test locations 450 tested by the plurality of second regression tests.

Put another way, the regression test selection module 415 may include further instructions that, when implemented, cause the processor 402 to: exclude a second regression test from testing the application when the source code change locations 435 of the application do not align with respective source code test locations 450 tested by the second regression test.

The regression test module 417 may include instructions that, when implemented, cause the processor 402 to: execute the regression test (and/or plurality of regression tests), as selected, on the source code test locations 240 of the application; and in response to the application passing the regression test (and/or the plurality of regression tests): return an indication of passing the regression test.

Similar to execution location markers 235 as described above, the application module 423 comprises the execution location markers 445. Hence, the application module 423 may include instructions that, when implemented, cause the processor 402 to: return executed source code line numbers executed during the regression test. Put another way, the execution location markers 445 may comprise instructions that, when implemented, cause the processor 402 to: return executed source code line numbers executed during the regression test

Similarly, the source code update module 425 may include instructions that, when implemented, cause the processor 402 to: update the second database 422 with the executed source code line numbers associated with the regression test, the executed source code line numbers comprising respective source code test locations 450 tested by the regression test.

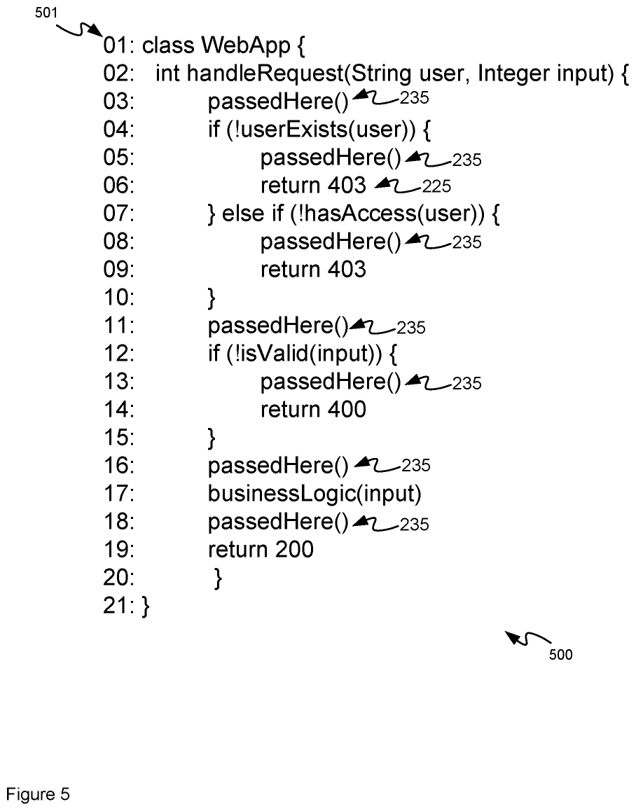

An example of a source code change locations and execution locations markers 235 are next described with respect to FIG. 5. In particular, FIG. 5 depicts a code snippet 500 in Java-like code. Various functions, and other parts of the code snippet 500, are on various lines indicated by line numbering 501. The code snippet 500 may be an example of source code and execution locations markers 235 of the application engine 213, and/or the application module 423. While execution locations markers 235 are depicted in specific locations in the code snippet 500, the execution locations markers 235 may be located in any suitable location, and may be added manually and/or automatically.

The code snippet 500 generally performs an authorization of a user based on a string “user” received, along with an integer “input”, for example in a request to process the code snippet 500 (e.g., a request to process the application engine 213, and/or the application module 423; it is understood that processing the application engine 213, and/or the application module 423, may include controlling the hardware and/or software of the application engine 213 and/or the application module 423, to implement and/or process an application and/or executable instructions of the application engine 213, and/or the application module 423).

The code snippet 500 performs an authorization of the “user” for example by determining, at a first conditional path (e.g., line numbers “04” to “06”), whether the “user” exists, for example in a database, and the like (e.g., via a function “!userExists(user)”). In other words, when the first conditional path is executed, at least line numbers 03 to 06 and 11 are executed.

If the “user” exists, determining, at a second conditional path (e.g., line numbers “07” to “09”), whether the “user” has access (e.g., via a function “!hasAccess(user)”), for example to implement a function “business logic(input)”. In other words, when the second conditional path is executed, at least line numbers 07 to 09 are executed.

As depicted, when the user does not exist, at the first conditional path a “403” code is returned at line number “06” which may indicate an error (e.g., the 403 code may correspond to a HyperText Transfer Protocol (HTTP) “forbidden” error).

In the depicted example, it is understood that a change has been made to line number 6. Hence line number 06 may be stored at the first database 211 as a source code change location 225 for an application that includes the code snippet 500. Put another way, the line number 06 corresponds to a source code change location 225 that may be tested by a regression test. Hence, for example, a regression test that tests a source code test location 240 that includes line number “06” may be selected by comparing line number “06” to source code test locations 240 to determine regression tests associated with source code test locations 240 that include the line number “06”.

For example, an identifier 241 of a regression test may be associated with a source code test location 240 that indicates that line numbers 04 to 06 and 11 are tested by the regression test.

As depicted, the code snippet 500 further comprises execution location markers 235, for example a function “passedHere( )” which, when executed, may return an indicator of a source code location being executed, such as a line number of where the function “passedHere( )” is located. For example, the function “passedHere( )” at line number 05 on the first conditional path, may respectively return “05” when the first conditional path is executed. Hence, when a regression test executes the first conditional path, the line number “05” may be returned and stored as a source code test location 240 in association with an identifier 241 of the regression test. Furthermore, such a regression test may only test the first conditional path and not other conditional paths in the code snippet 500.

Similarly, when a regression test executes the second conditional path, the line numbers “08” (e.g. due to the function “passedHere( )” being at line 08) may be returned and stored as a source code test locations 240 in association with an identifier 241 of the regression test that tests the second conditional path. Furthermore, such a regression test may only test the second conditional path and not other conditional paths in the code snippet 500.

The source code location update engine 215 may be to receive line numbers and/or executed source code locations executed by a regression test, and determine associated conditional paths and/or source code test locations 240. Indeed, any suitable process for determining a conditional path and/or source code test locations 240 based on executed source code locations executed by a regression test (such as line numbers generated by the execution location markers 235), is within the scope of the present specification.

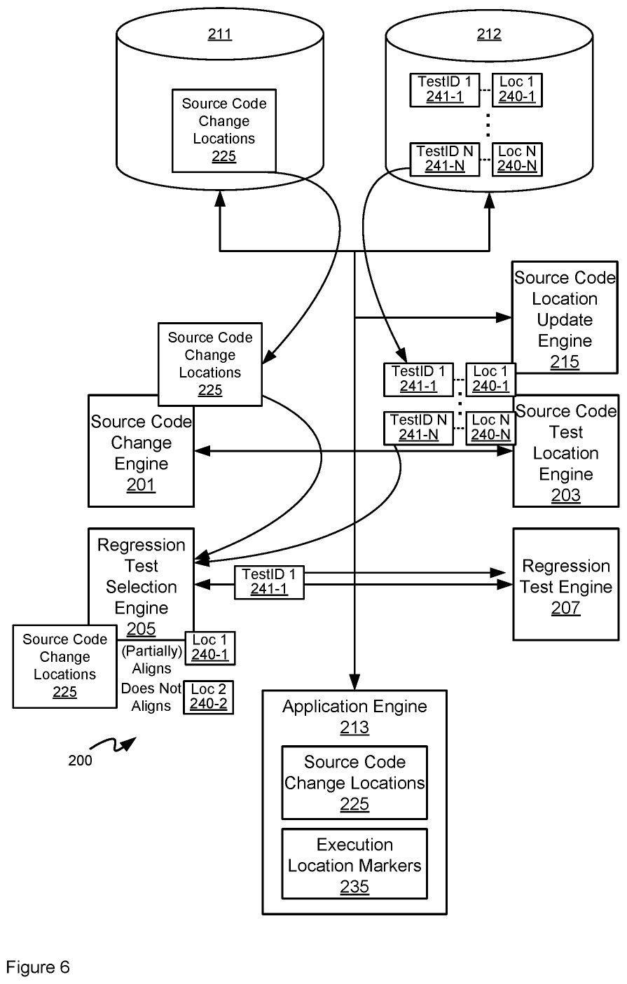

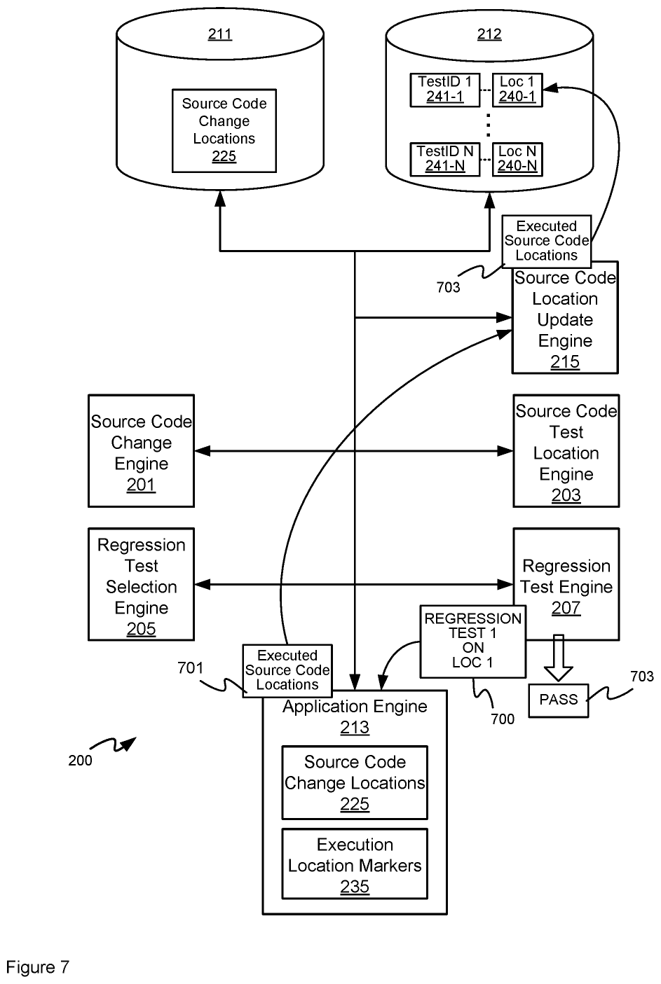

Attention is next directed to FIG. 6 and FIG. 7 which depicts the system 200 implementing the method 300. In FIG. 6, it is understood that regression tests identified by the identifiers 241 have been executed on the application of the application engine 213, such that the second database 212 has been populated with the source code test locations 240.

With attention first directed to FIG. 6, the source code change engine 201 retrieves (e.g., at a block 301 of the method 300) the source code change locations 225 from the first database 211, and the source code test location engine 203 retrieves (e.g., at a block 303 of the method 300) the source code test locations 240 (e.g., and the associated identifiers 241) from the second database 212. The source code change engine 201 provides the source code change locations 225 to the regression test selection engine 205, and the source code test location engine 203 provides the source code test locations 240 (e.g., and the associated identifiers 241) to the regression test selection engine 205.

The regression test selection engine 205 selects (e.g., at the block 305 of the method 300) a regression test corresponding to the identifier 241-1 to test the application implemented by the application engine 213, as the source code change locations 225 align (and/or partially align) with the source code test locations 240-1. However as the as the source code change locations 225 do not align with the source code test locations 240-2, a regression test corresponding to the identifier 241-2 is not selected.

The regression test selection engine 205 provides the identifier 241-1 to the regression test engine 207.

With attention next directed to FIG. 7, which continues from FIG. 6, the regression test engine 207 executes 700 (e.g., at the block 307 of the method 300) the regression test corresponding to the identifier 241-1 (e.g., “REGRESSION TEST 1”) on the source code test locations 240-1 of the application implemented by the application engine 213.

The execution location markers 235 of the application engine 213 generate source code locations 701 executed during the regression Test and the source code locations 701 are received at the source code location update engine 215, which updates (e.g., at the block 309 of the method 300) the source code test locations 240-1 with the source code locations 701 at the second database 212.

In the example of FIG. 7, the regression test is passed (e.g., a “YES” decision occurs at the block 311 of the method 300) and the regression test selection engine 205 returns an indication 703 of passing the regression test.

It should be recognized that features and aspects of the various examples provided above may be combined into further examples that also fall within the scope of the present disclosure.

1. A system comprising:
a source code change engine to: retrieve a source code change location in an application, as maintained at a first database;
a source code test location engine to: retrieve a source code test location, tested by a regression test, as maintained at a second database in association with the regression test;
a regression test selection engine to: select the regression test to test the application based on comparing the source code change location for the application with the source code test location associated with the regression test; and
a regression test engine to: execute the regression test, as selected, on the source code test location of the application; and in response to the application passing the regression test, return an indication of passing the regression test.

2. The system of claim 1, further comprising a source code location update engine to:
receive, from the application, an executed source code location that was executed during the regression test; and
update the source code test location associated with the regression test, at the second database, with the executed source code location.

3. The system of claim 1, further comprising a source code location update engine to:
receive, from the application, an executed source code location that indicates a conditional path that was executed during the regression test; and
update the source code test location associated with the regression test, at the second database, with the executed source code location.

4. The system of claim 1, wherein the regression test engine is further to: in response to the application passing the regression test, cause the application to be deployed.

5. The system of claim 1, wherein the regression test engine is further to: in response to the application failing the regression test, return a respective indication of failing the regression test.

6. A method comprising:
retrieving, by a computing device, source code change locations of applications, as maintained at a first database;
retrieving, by the computing device, source code test locations, tested by regression tests, as maintained at a second database in association with the regression tests;
selecting, by the computing device, a regression test to test an application based on comparing the source code change locations for the application with the source code test locations associated with the regression tests;
executing, by the computing device, the regression test, as selected, on the source code test locations of the application, the application configured to return source code locations executed during the regression test;
updating, by the computing device, the source code test locations associated with the regression test, at the second database, with the source code locations returned by the application; and
in response to the application passing the regression test: returning, by the computing device, an indication of passing the regression test.

7. The method of claim 6, wherein returning the indication of passing the regression test comprises marking the application as a release candidate in a continuous integration environment.

8. The method of claim 6, further comprising:
in response to the application failing the regression test: returning, by the computing device, a respective indication of failing the regression test.

9. The method of claim 6, further comprising:
in response to the application failing the regression test: marking, by the computing device, the application as not a release candidate in a continuous integration environment.

10. The method of claim 6, wherein the source code change locations, the source code test locations, and the source code locations returned by the application comprise source code line numbers.

11. A non-transitory computer-readable medium comprising instructions that, when executed by a processor, cause the processor to:
communicate with a first database to retrieve source code change locations of applications;
communicate with a second database to retrieve source code test locations tested by regression tests;
select a regression test that tests the source code change locations of an application based on determining the source code change locations that align with the source code test locations tested by regression tests; and
execute the regression test, as selected, on the source code test locations of the application; and
in response to the application passing the regression test: return an indication of passing the regression test.

12. The non-transitory computer-readable medium of claim 11, wherein the instructions, when executed, further cause the processor to:
return executed source code line numbers executed during the regression test; and
update the second database with the executed source code line numbers associated with the regression test, the executed source code line numbers comprising respective source code test locations tested by the regression test.

13. The non-transitory computer-readable medium of claim 11, wherein the source code change locations and the source code test locations comprise line numbers of the applications.

14. The non-transitory computer-readable medium of claim 11, wherein the instructions, when executed, further cause the processor to:
exclude a second regression test from testing the application when the source code change locations of the application do not align with respective source code test locations tested by the second regression test.

15. The non-transitory computer-readable medium of claim 11, wherein the instructions, when executed, further cause the processor to:
select a plurality of first regression tests, including the regression test, to test the source code change locations changed in the application based on determining the source code change locations that align with first respective source code test locations tested by the plurality of first regression tests; and exclude a plurality of second regression tests from testing the application based on determining the source code change locations do not align with second respective source code test locations tested by the plurality of second regression tests.
